(19) United States
(12) Patent Application Publication
(10) Pub. No.: US 2010/0232864 A1
(43) Pub. Date: Sep. 16, 2010

(54) WRITING INSTRUMENT HAVING A MOVABLE ORNAMENT MOUNTED THEREON

(76) Inventor: Pao-Feng LEE, Taipei (TW)

Correspondence Address: SALLY CHANG, 3F-8 No.6, SEC. 6 CHUNG-HSIAO EAST RD., TAIPEI, TAIWAN, R.O.C. 115, TAIPEI, 115, TW

(21) Appl. No.: 12/719,017

(22) Filed: Mar. 8, 2010

Related U.S. Application Data
(63) Continuation-in-part of application No. 12/461,629, filed on Aug. 19, 2009.

(30) Foreign Application Priority Data
Mar. 11, 2009 (TW) 098203698

(51) Int. Cl. B43K 7/12

(52) U.S. Cl. 401/99

(57) ABSTRACT

An amusement writing instrument with a mechanical toy consists of an elongated pen body having a seat mounted on an end, a toy housing said seat and a working piece passing through said seat. The working piece comprises of a rod, pluralities of driving elements driven by the rod and pluralities of resilient devices for providing reciprocal movement. The toy composes of a frontal and rear casings and a decorating object is further attached to the seat. The working piece is driven as the user propels the refill to disengage the frontal casings from the rear casing, creating a slit for allowing the decorating object to be extended and exposed.

This application is a Continuation-In-Part of application Ser. No. 12/461,629, filed on Aug. 19, 2009, now pending.

### FIELD OF THE INVENTION

The present invention relates to a writing instrument, more specifically a mechanical pen having a toy as an ornament mounted thereon and said ornament can be actuated to perform movement as the refill of pen is operated to move forward and backward.

### BACKGROUND OF THE INVENTION

Writing instrument, such as pen or pencil usually has a toy or ornament mounted on the top for increasing the beauty or providing appearance changing. The ornament is a symbol of fashion as it usually represents the preference of a user or the society. An integral molded figure of animal, famous cartoon characters or other objects are often mounted on a pen, chopsticks or others rod-like objects for attracting sight of others. The ornament often incorporates movable components which can be actuated as the retractable refill is operated as claimed in the cited references 1 and 2. The cited reference 1, designated with the publication number TW 264762, entitled “Pen with Funny Ornament” discloses two symmetrical casings, a gear set, a spherical compartment and a mechanical device for actuating said retractable refill. The mechanical toy is provided within said spherical compartment and is actuated by a magnet incorporated in said gear set. The cited reference 2, designated with the publication number TW M294429, entitled “Pen with Funny Ornament ” discloses a seat, a slide, a spear-like plate and a rod-like decoration. The plate is engaged with said slide and said plate triggers the decoration to perform swing movement as refill or lead of the pen moves is propelled or retracted. However, such monotonic decoration and simple movement bores the user easily as it lacks change of the shape of the ornament. Therefore, to provide an ornament with movable part which can drive the reaction of the object coupled with for increasing its amusing factor has become the objective of the present invention.

### SUMMARY OF THE INVENTION

To achieve foregoing objectives, the present invention relates to a mechanical pen which incorporates a retractable refill with a mechanical toy or ornament mounted thereon and the toy is driven in response to the action of the refill. The present invention can be realized in two embodiments. In the first embodiment, a toy comprises of a frontal and rear casings coupling each other for housing a seat and a decorating object. The object is attached to the seat which is connected to the mechanical device for extending and retracting the refill. The upper portion of the decorating object engages to a frame for securing the object as is concealed within the casings. As the refill is extended, both frontal and rear casings are separated and the decorating object is driven to be exposed therefrom.

In the second embodiment, the toy comprises of same mechanical structure as disclosed in the first embodiment. However, the monopiece frontal and rear casings are now formed by assembling two inner casings and outer casings. Said inner casings house the mechanical components of the toy and said outer casings can engage the inner casings and are exchangeable to add creativity and fun factor for the toy.

### BRIEF DESCRIPTION OF DRAWINGS

FIG. 1 is a perspective view of the first embodiment.

FIG. 2 is a cross sectional view of FIG. 1.

FIG. 3 is an enlarge view of FIG. 2 for demonstrating the details of mechanical components of the toy.

FIG. 4 is a schematic view of the mechanical structure of the present invention.

FIG. 5 is an exploded view of the first embodiment of the present invention.

FIG. 6 is a perspective view of the resilient device of the present invention.

FIG. 7 is a cross sectional view of the first embodiment, illustrating the decorating object accommodated within.

FIG. 8 is a perspective view of the second embodiment of the present invention.

FIG. 9 is an exploded view of the second embodiment of the present invention.

FIG. 10 is a cross sectional view of the second embodiment, illustrating the decorating object exposed

FIG. 11 is a cross sectional view of the first embodiment, illustrating the decorating object accommodated within

### DETAIL DESCRIPTION OF PREFERRED EMBODIMENTS

The preferred embodiments of the present invention are described in details hereinafter.

### First Embodiment

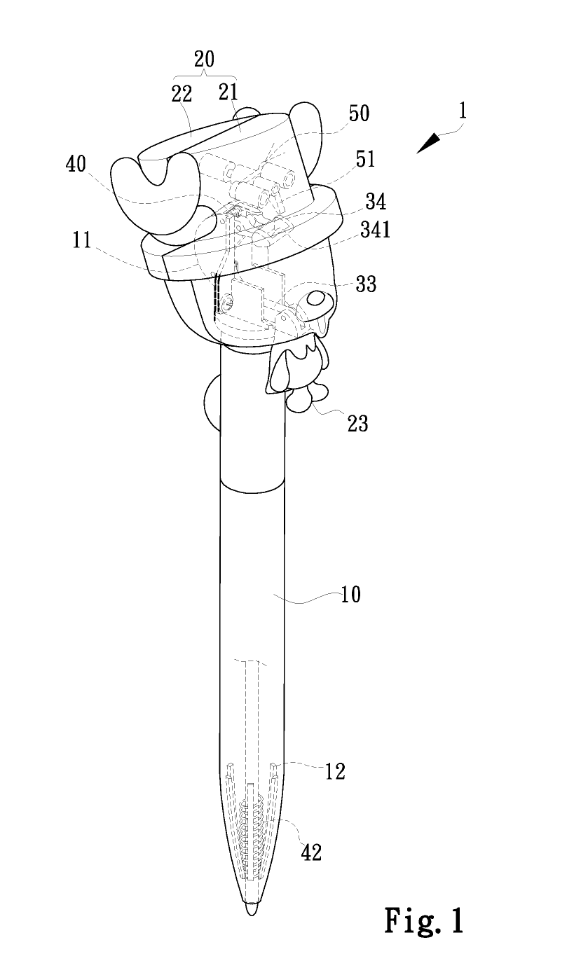

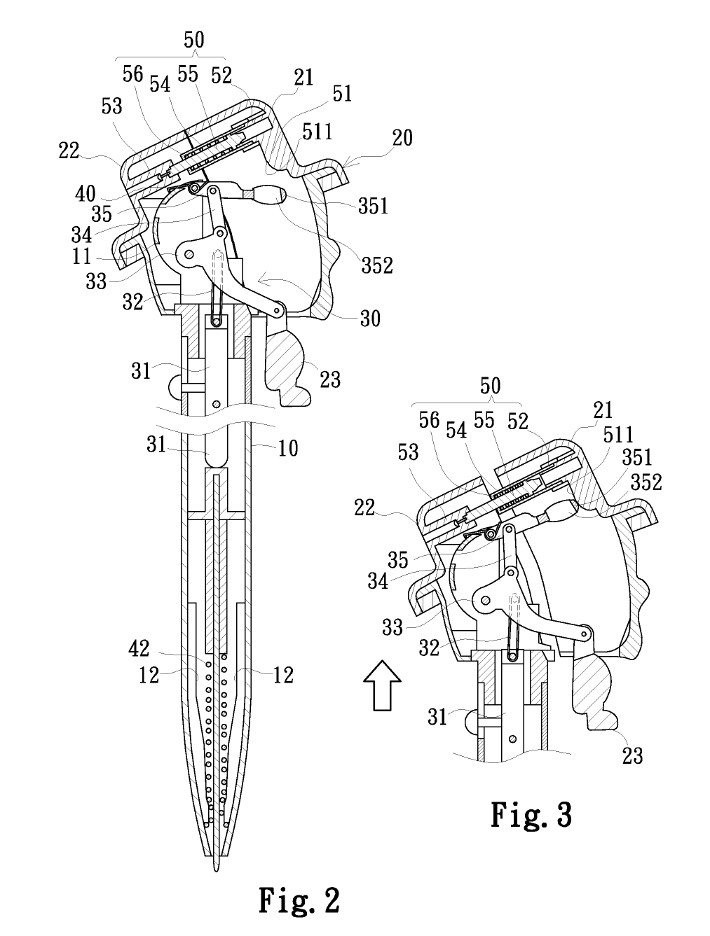

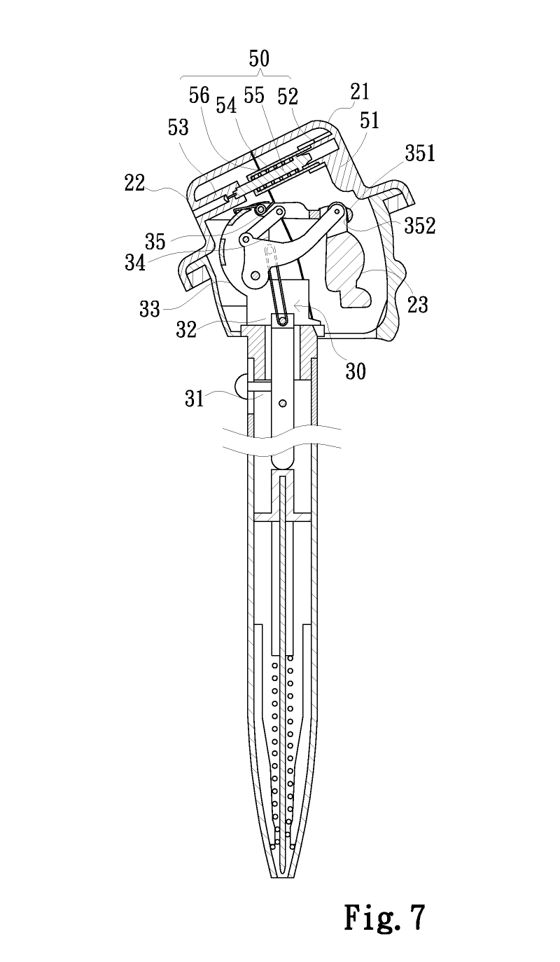

Referring to FIGS. 1-7, a writing instrument (1) coupling with a toy comprises of an elongated pen body (10) having a seat (11) mounted on an end thereof, a toy (20) covers said seat (11), and a working piece (30) engages with the seat (11) to drive said toy (20). Said working piece (30) consists essentially of a shaft (31) which attaches to the seat (11) and slides within said pen body (10), a first driving element (32) incorporated in the toy (20) and is driven by the shaft (31), a second driving element (33) pin jointed to first driving element (32) and seat (11) respectively, a third driving element (34) pin jointed to said second driving element (33), a fourth driving element (35) pin jointed to said third driving element (34) and the seat (11) respectively, a first elastic element (40) provided at where said fourth driving element (35) jointed the seat (11) to allow said second driving element (33) moves reciprocally and second elastic elements (41, 42) are incorporated in the pen body (10) for driving elements provided therein to move reciprocally. Said working piece (30) functions similar as disclosed in application Ser. No. 12/461,629, therefore no specific details is further described herewith. The pen body of the toy (20) is formed by a frontal and a rear casing (21, 22). The toy (20) houses a decorating object (23) pin jointed to said second driving element (33). Said frontal casing (21) is moved by the forth driving element (35) to form a space to allow the object (23) being exposed as the refill within the pen body (10) is propelled to expose for writing purpose.

The present invention is characterized in that said toy (20) further incorporates a resilient device (50) for limiting the movement of said frontal and rear casings (21, 22) of the toy. A butting member (51) which can be exerted by said fourth driving element (35) to lift the frontal casing (21) is provided at a bottom portion of said resilient device (50). A hollow frame (351) is provided at a top of said fourth driving element for securing the position of the decoration object (23).

Said frontal and rear casings (21, 22) are coupled through said resilient device (50) and the frontal casing (21) can be lifted to disengage with the rear casing (22) as said fourth driving element (35) is pushed against the butting member (51). As shown in FIG. 3, the frontal casing (21) is relatively larger than the rear casing (22) and both are connected slantwise to ensure the mechanical elements function smoothly.

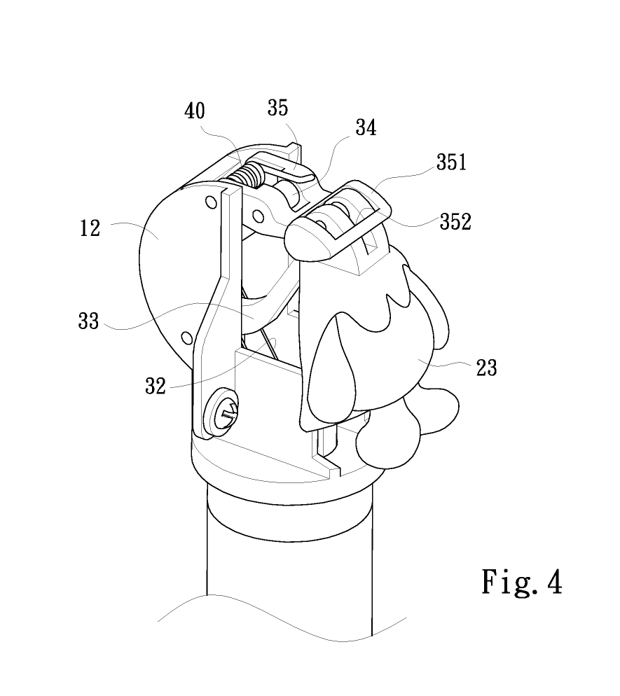

The decorating object (23) moves slightly within the toy (20) as the writing instrument (1) is utilized for writing purpose. Such swing movement can cause the object (23) jamming inside the toy (20). To secure the position of said object (23), the upper portion of the object (23) engages the frame (351). As shown in FIG. 4, the frame (351) comprises of a hollow portion (352) which corresponds to the shape of the object (23). Therefore, the object (23) is hold securely inside the toy (20).

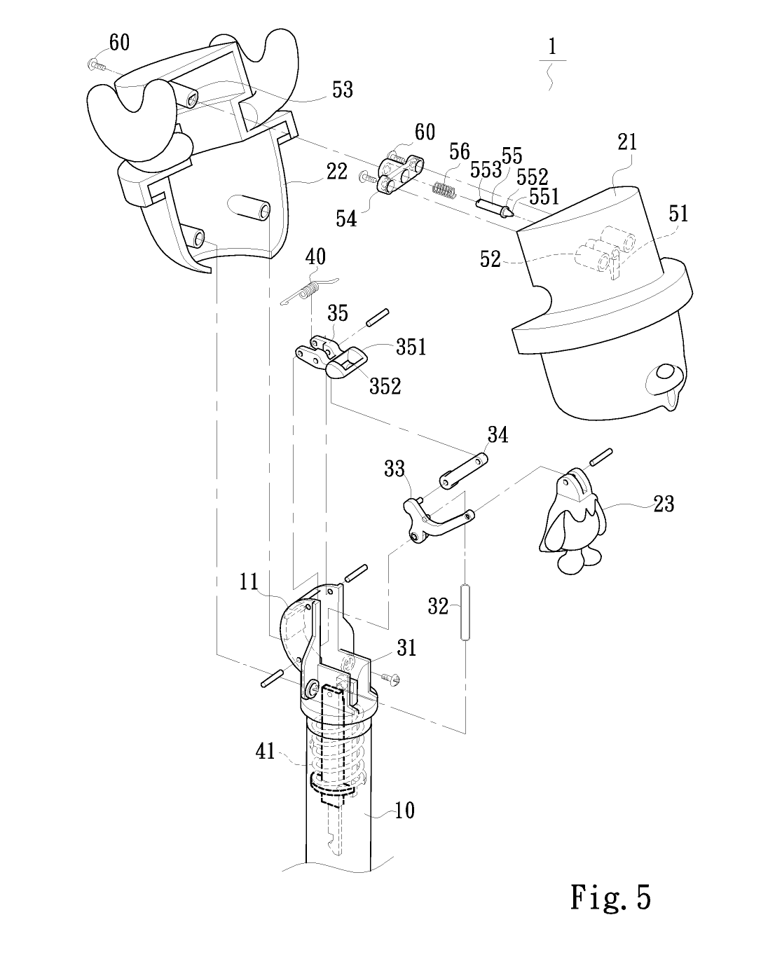

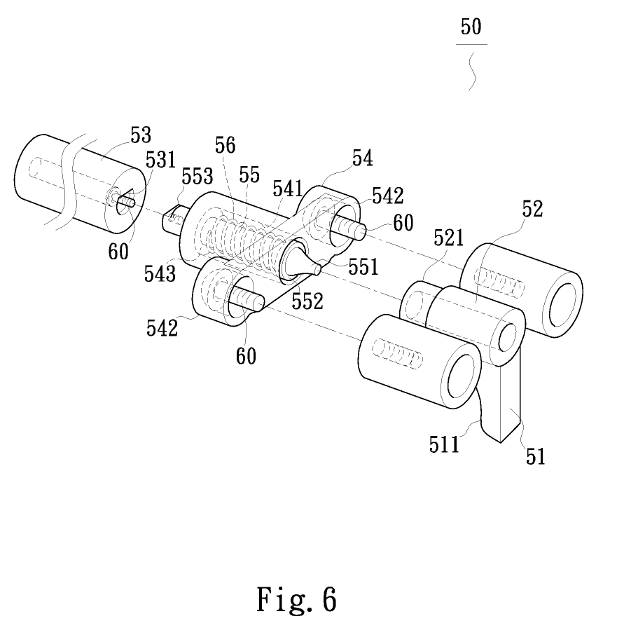

Said butting member (51), referring to FIGS. 5 and 6, includes a curved surface (511). Therefore, when the frame (351) can pushes against said surface (511) to create a slit between both casings (21, 22). The shape of said butting member (51) can be selected from a block, a rid or an arm according to the shape and structure of the frontal casing (21).

Referring to FIGS. 5-7, the resilient device (50) consists of a first fastening element (52) provided at the inner wall of the frontal casing (21) and a second fastening element (53) provided at inner wall of the rear casing (22), a positioning element (54) freely attaches to said first fastening element (52), a rod (55) for engaging said positioning element (54) to said second fastening element (53), and a spring (56) sheathing said rod (55) for proving reciprocal movement. Said first fastening element (52) and positioning element (54), rod (55) and second fastening element (53) are coupled and fastened. The resilient device (50) provides elasticity and supports the frontal casing (21) as the working piece (30) is not actuated.

An end of said rod (55) is a cone-shape point (551) for facilitating to engage with said first fastening element (52), and a stop ring (552) is provided about the point (551). A latch (553) is provided at another end of said rod (55) for fastening said second fastening element (53). A backstop (521) which corresponds to said stop ring (552) is provided at an end of said first fastening element (52) and a groove (531) is provided at an end of said second fastening element (53) for receiving the latch (553). The cone-shaped point (551) reduces the resistance as the rod (55) sliding reciprocally, and stop ring (552) prevents the rod (55) from going further and latch (553) avoids the rotation of the rod (55).

A cylindrical compartment (541) is sized at a center portion of an end of said positioning element (54) for accommodating said rod (55) and spring (56), and two locating elements (542) are provided at both sides of said compartment (541) for receiving screws (60) to fasten onto the first fastening element (52), and a stop ring (543) is provided at another end of said positioning element (54) for securing the spring (56). Both locating elements (542) facilitate said position element (54) be screwed onto the first fastening element (52), and the stop ring (543) assists the spring (56) to restore elastic power as the frontal casing (21) disengages.

A rib (12) is provided longitudinally around an inner bottom of said pen body (10) for securing said second resilient device (42) to avoid disengagement as the pen body (10) being disassembled.

### Second Embodiment

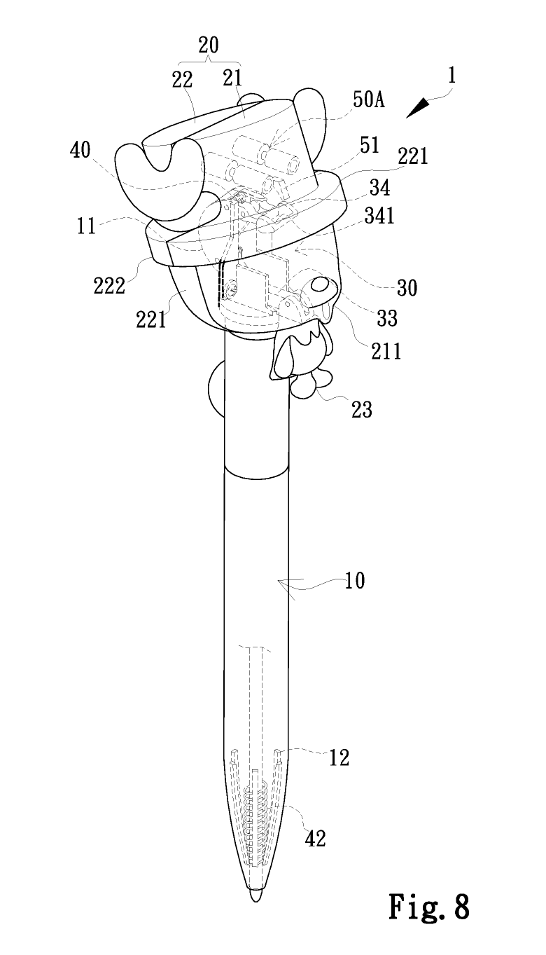

The second embodiment of the present invention is described and illustrated by referring to FIGS. 8-11. A toy (20) incorporates a resilient device (50A) for limiting the movement of a frontal and rear casings (21, 22) of the toy, and a butting member (51) which is actuated by said fourth driving element (35) to move the frontal casing is provided at the bottom portion of said resilient device (50A). Hollow frame (351) is provided at a top of said fourth driving element (35) for receiving and securing an upper portion of the decorating object (23). Each of said frontal and rear casings (21, 22) is composed of an inner casing (211, 221) for engaging with said resilient device (50A), and an outer casing (212, 222) sheathing said inner casings (211, 221). Said resilient device (50A) comprises of a first and second fastening elements (52, 53) disposed respectively at said frontal and rear inner casings (211, 221), two rods (55) for engaging said positioning element to said second fastening element, and two springs (56) sheathing the rods (55) respectively for proving reciprocal movement. a groove (522, 532) is provided respectively at said first and second fastening elements (52, 53), and a projected block (213, 223) which corresponds to said grooves (522, 532) is provided respectively at an inner wall of said frontal and rear outer casings (212, 222).

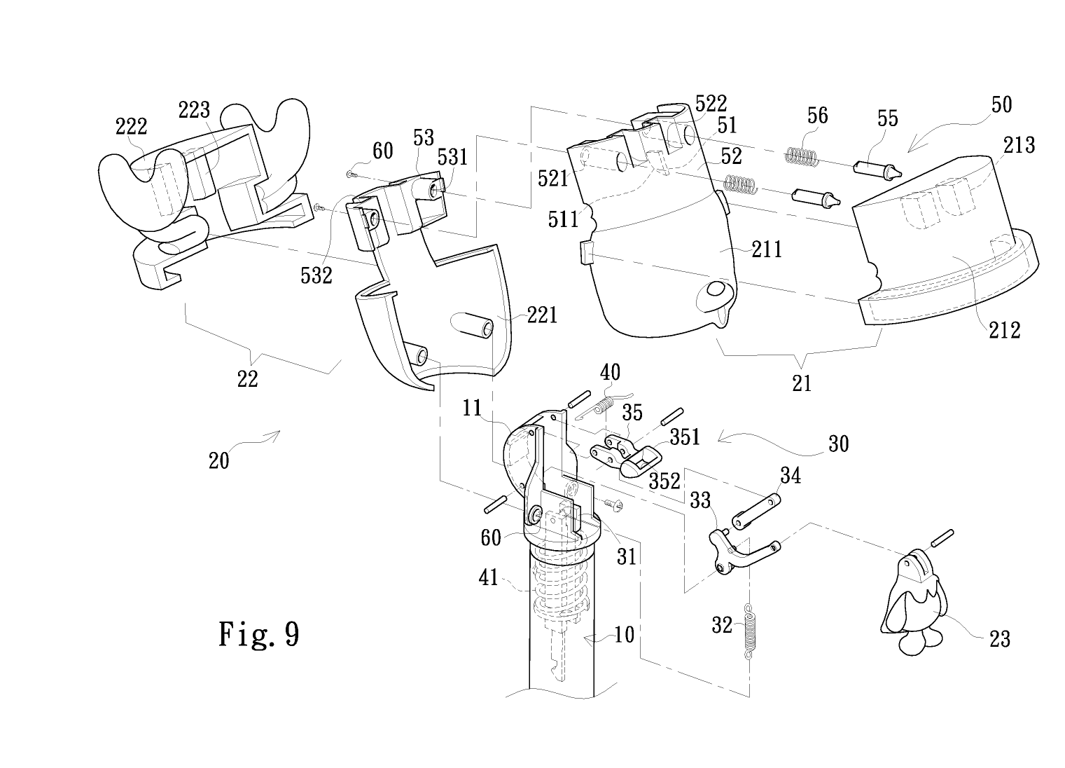

In contrast with the monopiece frontal and rear casings (21, 22) disclosed in the first embodiment, the frontal and rear casings (21, 22) of the second embodiment are composed of inner casings (211, 221) and outer casings (212, 222). As shown in FIG. 9, the toy (20) is attached to the pen body (10) by fastening the rear inner casing (221) onto the seat (11) with screws (30). It facilitates the assembling and disassembling procedures of toy (20) comparing to the first embodiment.

Assembling and disassembling of toy (20) with screws (30) and design of inner and outer casings provides more creativity and amusing factor to the toy (20) of the second embodiment as the outer casing (212, 222) can be replaced by other variations to avoid user being bored with monotonic design.

The rod (55) of the resilient device (50A) has the same shape as disclosed in the first embodiment and is disposed at the left and right side of the inner side of the toy (20). A front end of each rod (55) passes through the frontal inner casing (211) and a rear end thereof is guided into a locating hole (531) of the second fastening element (53) and is fastened thereon with screws (60). The resilient device (50A) of the second embodiment is relatively stronger in structural strength and the dual springs design provided better elasticity.

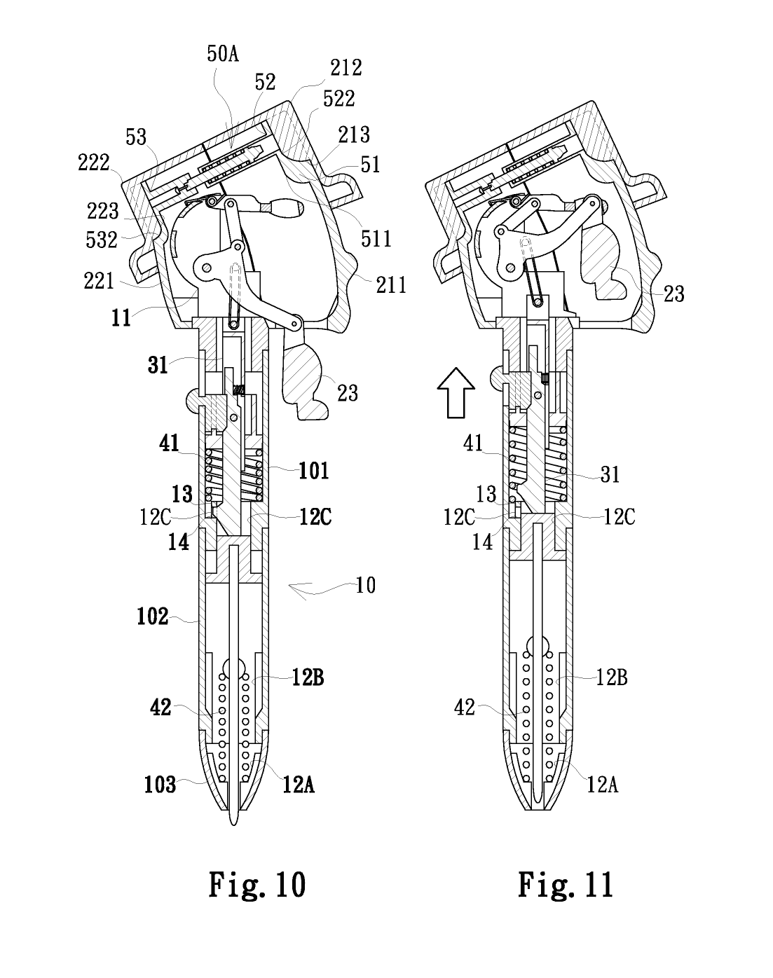

The pen body (10) of the second embodiment, referring to FIGS. 10 and 11, consists of an upper tubular portion (101) incorporating the shaft (31) and the second elastic element (42), a lower tubular portion (102) whose an end engages the upper tubular portion (101) incorporates a refill and a cap (103) mounted to another end of the portion (102). The seat (11) is later mounted onto the top of the upper tubular portion (101).

A plurality of first ribs (12A) and second ribs (12B) are provided at an inner wall of said pen body (10) for securing the second elastic element (42), a plurality of third ribs (12C) are further provided for securing another second elastic element (41). An arm (13) is provided between each third rib (12C) for connecting each other, and a hole (14) is sized at a bottom thereof for engaging with the shaft (31). Said third ribs (12C) are provided at the inner bottom of said upper tubular portion (101) to avoid disengagement of the second elastic element (41). The second ribs (12B) are disposed at the inner bottom of said lower tubular portion (102) and the first ribs (12A) are provided at the inner wall of the cap (103) to avoid the disengagement of the second elastic element (42).

1. A writing instrument with a mechanical toy comprises of an elongated pen body having a seat mounted on an end thereof, a toy covers said seat, and a working piece engages with the seat to drive movement of toy; said working piece consists essentially of a shaft which attaches to the seat and slides within said pen body, a first driving element incorporated in the toy in response to the action of said shaft, a second driving element pin jointed to said first driving element and seat respectively, a third driving element pin jointed to said second driving element, a fourth driving element pin jointed to said third driving element and the seat respectively, a first elastic element provided at where said fourth driving element jointed to the seat to allow said second driving element moves reciprocally, and at least one second elastic element incorporated in the pen body for above driving elements provided therein to move reciprocally; the toy which incorporates a decorating object pin jointed to said second driving element is characterized in that:
said toy further incorporates a resilient device for limiting the movement of a frontal and rear casings of the toy; a butting member which is exerted by said fourth driving element for lifting the frontal casing is provided at a bottom portion of said resilient device; a hollow frame is provided at a top of said fourth driving element for engaging the decorating object.

2. The writing instrument coupling with a toy of claim 1, wherein said butting member includes a curved surface.

3. The writing instrument with a mechanical toy of claim 1, wherein said butting member which provided on an inner wall of said frontal casing and is selected from a projected block, rib or a column.

4. The writing instrument with a mechanical toy of claim 1, wherein said resilient device comprises of a first and second fastening elements disposed respectively at said frontal and rear casings, a demountable positioning element is attached to said first fastening element, a rod for engaging said positioning element to said second fastening element, and a spring sheathing said rod for proving reciprocal movement.

5. The writing instrument with a mechanical toy of claim 4, wherein an end of said rod is in a coned point for engaging with said first fastening element, and a stop ring is provided about said point; a latch is provided at another end of said rod for securing said second fastening element; a backstop which corresponds to said stop ring is provided at an end of said first fastening element and a groove is provided at an end of said second fastening element for receiving the latch.

6. The writing instrument with a mechanical toy of claim 4, wherein a compartment is sized at a center portion of an end of said positioning element for accommodating said rod and spring, and two locating elements are provided at both sides of said compartment for receiving screw to fasten onto the first fastening element, and a stop ring is provided at another end of said positioning element for securing the spring.

7. The writing instrument with a mechanical toy of claim 1, wherein a rib is provided longitudinally encircled an inner bottom of said pen body for securing said second resilient elements.

8. A writing instrument with a mechanical toy comprises of an elongated pen body having a seat mounted on an end thereof, a toy covers said seat, and a working piece engages to the seat to drive movement of toy; said working piece consists essentially of a shaft which attaches to the seat and slides within said pen body, a first driving element incorporated in the toy and is driven by the shaft, a second driving element pin jointed to first driving element and seat respectively, a third driving element pin jointed to said second driving element, a fourth driving element pin jointed to said third driving element and the seat respectively, a first elastic element provided at where said fourth driving element jointed the seat to allow said second driving element moves reciprocally and at least one second elastic element incorporated in the pen body for driving elements provided therein to move reciprocally; the toy which incorporates a decoration pin jointed to said first and second driving elements is characterized in that:
said toy further incorporates a resilient device for limiting the movement of a frontal and rear casings of the toy; a butting member which is exerted by said fourth driving element to lift the frontal casing is provided at a bottom portion of said resilient device; a hollow frame is provided at a top of said fourth driving element for receiving the decoration; said frontal and rear casings further include two inner casings for engaging with said resilient device, and two outer casings sheathing said inner casings.

9. The writing instrument with a mechanical toy of claim 8, wherein said resilient device comprises of a first and second fastening elements disposed respectively at said frontal and rear casings, two rods for engaging said positioning element to said second fastening element, and two springs sheathing said rods respectively for proving reciprocal movement; a groove is provided respectively at said first and second fastening elements, and a projected block which corresponds to said groove is provided respectively at an inner wall of said outer casings.

10. The writing instrument with a mechanical toy of claim 8, wherein a plurality of first and second ribs are provided at an inner wall of said pen body for securing one of said second resilient device, a plurality of third ribs are further provided for securing another second resilient device; each of third ribs is connected by an arm, and a hole is sized at a bottom thereof for engaging the shaft.
